(19) United States
(12) Patent Application Publication
(10) Pub. No.: US 2004/0059578 A1
(43) Pub. Date: Mar. 25, 2004

(54) Method and apparatus for improving the quality of speech signals transmitted in an aircraft communication system

(76) Inventors: Stefan Schulz, Himmelpforten (DE); Thomas Eisenberg, Hamburg (DE); Manfred Endress, Buxtehude (DE)

Correspondence Address: FASSE PATENT ATTORNEYS, P.A., P.O. BOX 726, HAMPDEN, ME, 04444-0726, US

(21) Appl. No.: 10/668,722

(22) Filed: Sep. 22, 2003

Related U.S. Application Data
(60) Provisional application No. 60/413,029, filed on Sep. 23, 2002.

(30) Foreign Application Priority Data
Sep. 20, 2002 (DE) 102 43 955.9

(51) Int. Cl. G10L 11/00

(52) U.S. Cl. 704/270

(57) ABSTRACT

An aircraft speech transmission arrangement includes a speech receiver having a microphone, an audio output device, and an interposed speech processing system. This arrangement enables spoken communication between flight attendants and pilots, and spoken announcements to passengers. A speech analysis and evaluation module incorporated into the speech receiver evaluates the speech quality of the speech signal received by the microphone, by comparing it with reference parameters. If the speech quality is unacceptable, a quality feedback information signal is provided to a signaling device that indicates the unacceptable speech quality to the person speaking (the speaker). In response thereto, the speaker can improve the volume and clarity of the speech, as well as the position and orientation of the speech receiver relative to the speaker's mouth. This real-time feedback of the received speech quality allows the speaker to optimize factors that influence the received speech quality while speaking.

### CROSS-REFERENCE TO RELATED APPLICATION

This U.S. Non-Provisional Application claims the benefit under 35 U.S.C. §119(e) of U.S. Provisional Application 60/413,029, filed on Sep. 23, 2002, the entire disclosure of which is incorporated herein by reference.

### PRIORITY CLAIM

This application is based on and claims the priority under 35 U.S.C. §119 of German Patent Application 102 43 955.9, filed on Sep. 20, 2002, the entire disclosure of which is incorporated herein by reference.

### FIELD OF THE INVENTION

The invention relates to a method as well as an apparatus for transmitting speech signals using a speech transmission arrangement, especially in an aircraft.

### BACKGROUND INFORMATION

Modern aircraft and especially commercial passenger transport aircraft are typically equipped with a communication system in the aircraft cabin and the cockpit, which enables spoken communication between the flight attendants and/or the pilots and/or the other flight crew personnel, and also allows spoken announcements to be made to the passengers. Such aircraft communication systems or aircraft speech receiving and transmitting arrangements, typically include a speech receiving device or receiver, a speech processing system including at least an amplifier and a switching system, as well as one or more audio output devices, for example comprising loudspeakers. The speech receiver includes a microphone and can be embodied as a telephone-type handset, a handheld microphone, or a headset including a microphone, for example.

To communicate using the communication system, a person such as a flight attendant (generally called a “speaker” herein) speaks toward or into the microphone, which picks up the resulting primary sound wave speech signal and generates a corresponding converted electrical signal, which is then further processed in digital or analog form in the speech processing system, to provide a processed speech information signal that is delivered to the audio output device (e.g. loudspeaker), which in turn regenerates a recovered sound wave speech signal that is broadcast to one or more persons (such as passengers, generally called “hearers” herein) who are intended to hear the spoken communication.

It is a disadvantage and sometimes problematic with such speech communication systems, that the quality of the speech signal to be transmitted is strongly dependent on several factors, at least some of which can be influenced more or less by the speaker. Namely, such factors will at least partially determine whether a qualitatively “good” or “bad” speech signal is finally perceived by the hearer after the signal has been transmitted over the transmission path. For example, the individual speech characteristics of each respective speaker will have a substantial influence on the quality of the speech information that is to be processed and transmitted to the hearer. Interfering noises in the surrounding environment of the speaker, which will also be picked up by the microphone, as well as the particular technology used for the components of the communication system and especially the speech processing will also have an influence on the quality (e.g. the clear audibility and understandability) of the speech signal ultimately perceived by the hearer. Furthermore, the precise position and orientation of the microphone relative to the speaker (particularly the larynx and/or mouth of the speaker) has a significant influence on the speech quality of the speech signal picked up as a sound wave by the microphone and ultimately transmitted to the hearer. Since this relative position of the microphone is variable dependent on the situation, and dependent on the personal microphone handling practices of the user, i.e. the speaker, it is not possible to guarantee the optimum handling or positioning of the microphone in all cases. Thus, the quality of the speech signal to be transmitted fluctuates or varies along with a varying position or handling of the microphone by the speaker, and due to possibly present interfering noises, and further dependent on the volume and the clear diction and pronunciation of the spoken communication, i.e. the original speech signal, by the speaker. The prior art has not provided any way of evaluating and optimizing these factors which can be influenced by the speaker.

Various different arrangements and methods are known in the prior art for processing a speech signal and evaluating the speech signal quality thereof. For example, U.S. Pat. No. 5,684,921 (Bayya et al.) discloses a method and system for identifying a corrupted speech message signal in a voice messaging system. A telephone caller records a message in the voice messaging system. At the end of the recording, if the recorded message is of poor speech quality, e.g. too noisy due to interference in the cellular telephone transmission channel, the system then informs the caller of the poor quality of the recorded speech signal, so that the caller can repeat the message to be recorded. Particularly, the system and method involve evaluating the speech message signal to determine whether the speech signal quality, e.g. the noise level, of the recorded message is within an acceptable range. Then, if the speech signal quality is outside of the acceptable range, i.e. the received signal is too noisy, then a signal is transmitted to the caller, indicating that the speech signal quality is poor, e.g. the noise level is excessive. The disclosure of U.S. Pat. No. 5,684,921 is incorporated herein by reference for background and supplemental information regarding speech processing and speech signal quality evaluation methods and systems.

Such conventional methods and systems represented by U.S. Pat. No. 5,684,921 suffer problems and disadvantages and are not suitable for application in a real-time communication system that immediately and directly transmits a speech signal from a speaker to a hearer, because the conventional method and system require the spoken message to be recorded before being evaluated and before indicating to the user whether the quality of the recorded message was acceptable. This does not allow an immediate real time communication between a speaker and a hearer, and does not allow the speaker to take corrective measures in real-time or “on the fly” while continuing to speak. Also, the prior art methods and systems are directed especially at addressing poor signal quality of the speech signal as received by the ultimate recipient (i.e. the “hearer”) arising due to interference and the like in the transmission of the speech signal via a cellular radio channel for example, rather than poor speech quality of the original speech, i.e. the spoken sound wave that is picked up by the caller's receiver microphone. Thus, the prior art methods and systems do not enable or prompt the speaker to take direct corrective measures that will improve the quality of the original sound wave speech signal that is picked up by the microphone.

### SUMMARY OF THE INVENTION

In view of the above, it is an object of the invention to provide a method as well as an apparatus which make it possible in a simple and economical manner, to evaluate the speech quality of the speech signal that is to be transmitted and to indicate the determined speech quality to the speaker in real-time, so as to allow the speaker to take corrective measures to improve the speech quality, especially by improving factors that influence the speech reception by the microphone. Thereby, the invention further aims especially to improve the spoken communication within an aircraft cabin using an aircraft speech transmission arrangement. The invention further aims to avoid or overcome the disadvantages of the prior art, and to achieve additional advantages, as apparent from the present specification.

The above objects have been achieved according to the invention in a speech transmission arrangement and especially (but not necessarily) an aircraft speech transmission arrangement, comprising a speech receiving device or apparatus, an audio output device, and a speech processing system connecting the speech receiving apparatus to the audio output device. The speech receiving apparatus incorporates a microphone to receive an input speech signal, and further incorporates an apparatus for speech analysis and evaluation adapted to analyze and evaluate the speech signal. The apparatus further includes a signaling device that is connected to a speech quality feedback output of the apparatus for speech analysis and evaluation and is located in an area or range of perception of the speaker. The signaling device may comprise an audio signaling device such as a loudspeaker or tone generator, a tactile signaling device such as a vibration generator, or a visual signaling device such as a light emitting device or a display screen. The signaling device is actuated responsive to and dependent on a speech quality feedback information signal that is generated by the speech analysis and evaluation apparatus, indicative of the evaluated speech quality of the speech signal being received by the microphone.

The above objects have further been achieved according to the invention in a method for processing and preferably transmitting speech signals, especially and preferably (but not necessarily) using an aircraft speech transmission arrangement. In the method, a speech signal in a sound wave through the air is received by a microphone of a speech receiving apparatus which converts the input speech signal to a corresponding converted signal (e.g. an analog or digital, electrical or optical signal), the speech quality of the speech signal represented in the converted signal is analyzed in an apparatus for speech analysis and evaluation, and is compared with reference parameters so as to allocate a quality measure for the speech quality to the speech signal. If the determined measure of the speech quality does not reach a predetermined sufficient or acceptable speech quality, then a quality feedback information signal is generated dependent on and indicative of the determined speech quality. This signal can actuate a signaling device to emit a humanly perceptible feedback signal in the area or range of perception of the speaker of the speech signal so as to notify the speaker of the determined speech quality.

The speech quality of the speech signal may be evaluated based on the signal-to-noise ratio (SNR), the magnitude of the signal level, and/or the constancy of the signal level of the speech signal. The humanly perceptible feedback signal is provided as an optical, acoustic, or mechanical/tactile signal to the speaker. In this manner, the speaker receives an indication in real-time regarding the speech quality of the speech signal being picked up by the microphone and processed and transmitted through the communication system. In the event an inadequate or unacceptable speech quality is indicated to the speaker, the speaker can take corrective measures, such as speaking more loudly or more clearly, or properly adjusting the spacing distance and/or the relative angular orientation and position of the microphone relative to the speaker's mouth and/or larynx. This allows the speaker to make “on the fly” corrections of the speech quality during the ongoing speaking of the spoken communication.

### BRIEF DESCRIPTION OF THE DRAWINGS

In order that the invention may be clearly understood, it will now be described in connection with an example embodiment, with reference to the accompanying drawings, wherein:

FIG. 1 is a schematic overview of an aircraft speech transmission arrangement in which the inventive method and system are implemented; and

FIG. 2 is a schematic diagram of the inventive system for analyzing and allowing improvement of the speech quality.

### DETAILED DESCRIPTION OF A PREFERRED EXAMPLE EMBODIMENT AND OF THE BEST MODE OF THE INVENTION

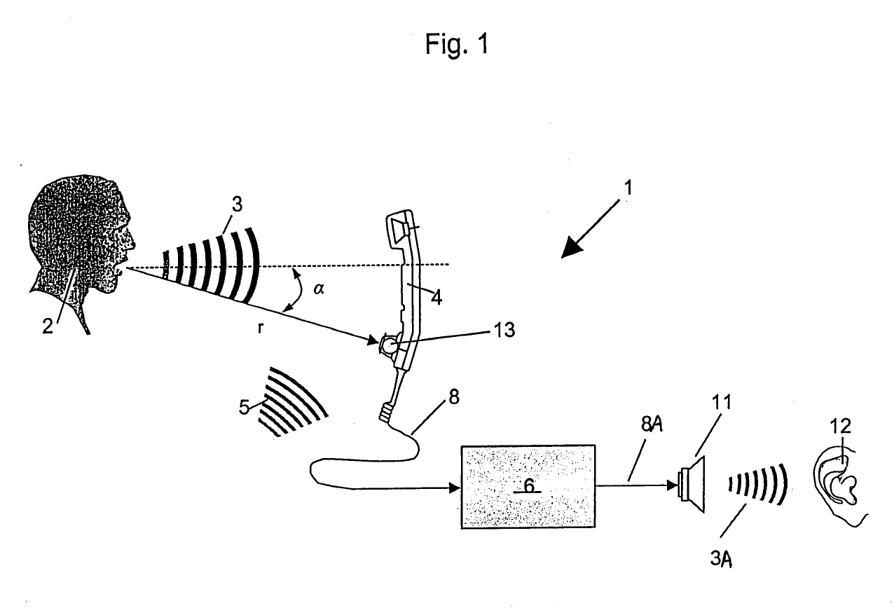

FIG. 1 schematically illustrates an aircraft speech transmission arrangement 1 including a speech receiving apparatus 4, and an audio output device 11 such as a loudspeaker, connected to each other through a speech processing system 6. In the illustrated example, the speech receiving apparatus 4 is embodied as a telephone-style handset with an incorporated microphone 13, although other examples of the speech receiving apparatus 4 include a handheld microphone or an audio headset including a microphone. In any event, the speech receiving apparatus 4 is to pick up an input speech signal 3 of an incident sound wave by means of the microphone 13, which generates a corresponding converted (e.g. electrical) speech signal or speech information 8 in digital or analog form, which is provided to the speech processing system 6. After processing the input speech information 8 in any conventionally known manner, for example at least including amplification, filtering, and switching or selection of desired output channels, the speech processing system 6 provides a processed output speech information signal 8A to the audio output device 11 comprising one or more loudspeakers, which generate a recovered output speech signal 3A that is to be audibly perceived by one or more hearers 12, e.g. passengers, who are the intended recipients of the spoken communication.

In order to use the aircraft speech transmission arrangement 1, a speaker 2 (e.g. a flight attendant) speaks so as to generate the sound wave carrying the input speech signal 3 representing the spoken communication, in a direction toward the microphone 13 of the speech receiving apparatus 4. In this regard, the speech quality of the speech signal 3 to be transmitted is strongly dependent on several factors that can respectively be more or less influenced by the speaker 2. For example, the individual speech characteristics of each respective speaker, such as the volume of the speech and the clarity of the pronunciation, as well as external interfering noises 5 from the surrounding environment of the speaker 2, and further the particular handling or position and orientation of the speech receiving apparatus 4 relative to the mouth and/or larynx of the speaker 2, are all factors that have an influence on the speech quality of the input speech signal 3 received by the microphone 13.

By holding the mobile or portable speech receiving apparatus 4 in a particular position and orientation relative to the mouth and/or larynx of the speaker 2, the speaker thereby directly determines or specifies the transmission path through the air from the mouth or larynx of the speaker 2 to the microphone 13 of the speech receiving apparatus 4. This transmission path can be defined on the one hand by the spacing distance r between the larynx or mouth of the speaker 2 and the microphone 13 of the speech receiving apparatus 4, and on the other hand by the angle α between the speaking direction and the sensitive receiving part or sensitive axis of the microphone 13 of the speech receiving apparatus 4. Since these factors or parameters are directly selectable or influenceable by the speaker 2, it is an aim of the invention to prompt and assist the speaker 2 to adjust and preferably optimize these factors in a manner so as to optimize the speech quality of the speech signal 3 received by the microphone 13. Particularly, the invention aims to enable the speaker 2 to optimize the transmission path or interface between the larynx of the speaker 2 through the air to the microphone 13 of the speech receiving apparatus 4.

This is achieved according to the invention by detecting the speech signal, analyzing and evaluating the speech quality of the speech signal, and then providing immediate real-time feedback to the speaker 2 in the manner of speech quality indicators that prompt or guide the speaker 2 to appropriately adjust the position (and primarily the spacing distance r and the angle α) of the speech receiving apparatus 4 relative to the mouth and/or larynx of the speaker 2, and/or to improve the volume and/or the clarity of the spoken pronunciation of the speaker 2, in a manner so as to improve the speech quality of the speech signal 3 received by the microphone 13.

These inventive features are preferably carried out without interrupting, delaying, or altering the speech processing in the speech processing system 6, and the regeneration of the recovered output speech signal 3A by the loudspeaker or loudspeakers of the audio output device or devices 11, to be perceived by the hearer or hearers 12. Namely, the further processing of the input speech information 8 to provide the output speech information 8A is continuously carried out, preferably regardless of the determination of the speech quality of the input speech signal 3, and thus the spoken communication is continuously conveyed to the hearer 12. Meanwhile, the speaker 3 is given a feedback indication, continuously or as necessary, of the received speech quality in real-time, so that the speaker 2 can make adjustments as mentioned above for improving the speech quality “on the fly” while continuing the spoken communication.

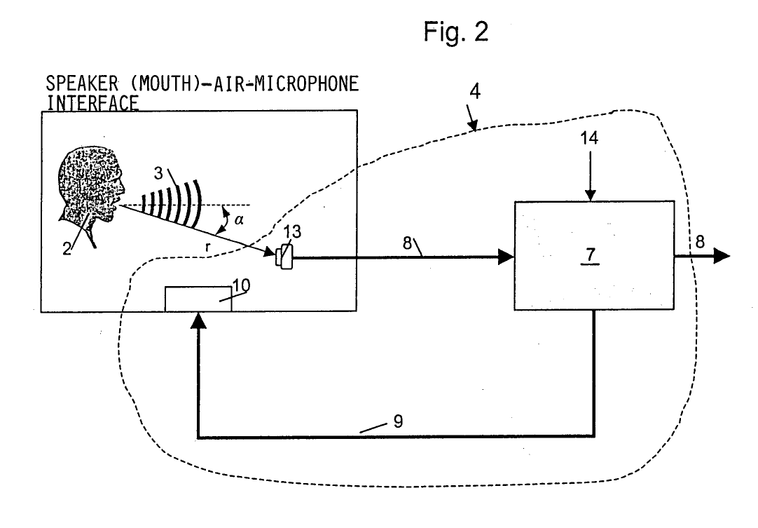

The above mentioned evaluation of the received input speech signal 3 is carried out in an apparatus or module 7 for speech analysis and evaluation as schematically shown in FIG. 2. This speech analysis and evaluation apparatus or module 7 is incorporated as a component in the speech receiving apparatus 4, and particularly the telephone-style handset 4 in the present embodiment. Generally, as explained above, the input speech signal 3 is picked-up by the microphone 13, which generates the corresponding converted (e.g. electrical) input speech signal 8, which is provided to the apparatus 7 for evaluation. If the speech information 8 has an adequate (i.e. acceptable) speech quality, then the apparatus 7 either generates no quality feedback information signal or a quality feedback information signal 9 that is indicative of a positive result, i.e. an acceptable speech quality. On the other hand, if the speech information 8 has an inadequate (i.e. unacceptable) speech quality, then the apparatus 7 generates or releases a quality feedback information signal 9 that is indicative of the inadequate speech quality.

Meanwhile, the input speech information 8 is passed on out of the speech receiving apparatus 4 to the speech processing system 6 shown in FIG. 1, preferably without alteration, i.e. preferably as if the speech quality analysis and evaluation apparatus 7 was not even interposed between the microphone 13 and the speech processing system 6. In this regard, instead of arranging the apparatus interposed in the signal line (8) as illustrated, the apparatus 7 could alternatively be connected to a side spur or branch line branched off from the signal line (8) while the main signal line (8) continues uninterrupted out of the handset 4. Namely, as mentioned above, the input speech information 8 is provided to the speech processing system 6 and ultimately the corresponding output speech signal 3A is generated and provided to the hearer or hearers 12 regardless whether the speech quality was determined to be acceptable or unacceptable in the apparatus 7.

More particularly, the apparatus 7 is preferably a programmable processing and computing unit (e.g. comprising a microprocessor or at least an arithmetic logic unit) with suitable speech evaluation software loaded therein. Any conventionally known techniques of speech analysis and evaluation can be employed in the apparatus 7. For example, analog and/or digital converted parameters are acquired from the input speech information 8, and these acquired parameters are compared with pre-defined reference parameters 14 (e.g. provided from a memory in which they are stored) that are indicative of an acceptable speech quality. In this manner, the input speech information 8 is evaluated and an evaluation result is generated so as to indicate the determined speech quality of the input speech information 8, e.g. at least whether the actual determined speech quality of the input speech information 8 is acceptable or unacceptable. The above mentioned parameters for evaluating the speech quality may, for example, comprise the signal-to-noise ratio (SNR), the magnitude of the signal level, the constancy of the signal level, or any conventionally known parameters pertinent in this regard.

Based on the determined result of the speech quality, the apparatus 7 generates or releases a corresponding quality feedback information signal 9 which is indicative of the determined speech quality. Note that it is also possible to omit, i.e. not to generate, the quality feedback information signal when the determined speech quality is acceptable, while only generating the quality feedback information signal when the determined speech quality is unacceptable, or vice versa. The generated quality feedback information signal 9 is provided to a signaling device 10 which responsively emits a humanly perceptible feedback signal that correspondingly indicates to the speaker 2 whether the determined speech quality is acceptable or unacceptable. If the feedback signal emitted by the signaling device 10 indicates an unacceptable speech quality, the speaker 2 is thereby prompted to carry out a real-time adjustment of the position and orientation, namely of the spacing distance r and/or of the angle a of the speech receiving apparatus 4 relative to the mouth and/or larynx of the speaker 2, and/or to improve the volume and/or the clarity of the spoken pronunciation of the speaker 2, so as to improve or optimize the speech quality of the received input speech signal 3. In this regard, the signaling device 10 can be an optical signaling device (e.g. a light emitting device or a display screen), an acoustic signaling device (e.g. a loudspeaker or tone generator), or a mechanical/tactile signaling device (e.g. such as a buzzer or vibrator), or may comprise a combination of various types of such signaling means.

For example, an optical signaling device 10 can comprise one or more selectively illuminatable or blinking lamps, light emitting diodes, or a display such as a liquid crystal display, which indicate an acceptable or unacceptable speech quality responsive to the quality feedback information signal 9. The lamps or LEDs may, for example, involve a green illuminated indication when the speech quality is acceptable, and a red (possibly blinking) illuminated indication when the speech quality is unacceptable, and perhaps additionally a yellow illuminated indication when the speech quality is in a “caution range” barely within the acceptable threshold. Alternatively or additionally, a display screen can provide similar indications of acceptable or unacceptable speech quality, or can even provide particular text message prompts for correcting or improving the speech quality, such as “speak louder” or “speak more clearly” or “speak closer to mike” or “adjust mike angle” responsive to particular corresponding quality deficiencies in the evaluated quality of the input speech information as received by the microphone. A tone generator as the signaling device 10 can be used instead of or in addition to the above described optical signaling devices, in order to audibly catch the attention of the speaker 2 and prompt a correction of the above mentioned speech reception factors.

Any such signaling devices 10 are preferably incorporated directly in the speech receiving apparatus 4, but may be arranged separately from the speech receiving apparatus 4 at any location within the range or area of relevant perception by the speaker 2. The selection of the particular signaling device or devices can be carried out dependent on the requirements, and e.g. dependent on the form or configuration of the particular speech receiving apparatus 4 being used in a given application.

As mentioned above, in one embodiment, the quality feedback information signal 9 is provided only at times when the speech quality is unacceptable and corrective measures need to be taken.

Alternatively, in another embodiment, the quality feedback information signal 9 is provided continuously during the entire spoken communication, to provide an ongoing indication of the varying determined speech quality level throughout the spoken communication. Any of the above described signaling devices 10 can be used continuously in this regard. Such an embodiment with continuous indication of the evaluated speech quality also facilitates training of the speaker 2, because it gives immediate ongoing feedback as to the proper handling and positioning of the speech receiving apparatus 4 as well as the speech volume and clarity of the speaker 2, while also immediately indicating the beneficial effects of corrective measures taken by the speaker 2.

Furthermore, such an embodiment simultaneously also allows the speaker 2 to monitor the functionality of the speech transmission arrangement. Namely, whenever the speaker 2 sees or otherwise perceives the quality feedback information signal via the signaling device 10, regardless of the actual indicated speech quality, the speaker 2 can recognize that the speech receiving apparatus 4 as well as the speech analysis and evaluation module 7 are functioning. On the other hand if no signal is indicated or emitted by the signaling device 10, then the speaker 2 can immediately recognize that there is a fault or malfunction of the microphone, the speech analysis and evaluation module, and/or the signaling device, for example.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A method of processing a speech signal, comprising the steps:
a) receiving a speech signal in a sound wave through air with a microphone in a speech receiving device, and, with said microphone, converting said speech signal to a converted signal representing said speech signal;
b) evaluating a speech quality of said speech signal by analyzing and comparing said converted signal with at least one reference parameter, to determine at least whether said speech quality of said speech signal as received by said microphone is acceptable or unacceptable; and
c) when said step b) determines that said speech quality is unacceptable or acceptable, then providing to a signaling device a quality feedback information signal dependent on and indicative of said speech quality determined as being unacceptable or acceptable.

2. The method according to claim 1, wherein said signaling device is located in said speech receiving device.

3. The method according to claim 1, further comprising emitting from said signaling device a humanly perceptible feedback signal in response to said quality feedback information signal, and dependent on and indicative of said speech quality determined as being unacceptable or acceptable.

4. The method according to claim 3, wherein said signaling device is located within a range of human perceptibility of said humanly perceptible feedback signal by a human speaker who is generating said speech signal by speaking.

5. The method according to claim 3, wherein said signaling device is an optical signaling device, and said humanly perceptible feedback signal is a visible feedback signal.

6. The method according to claim 5, wherein said visible feedback signal includes a visible text message.

7. The method according to claim 3, wherein said signaling device is an acoustic signaling device, and said humanly perceptible feedback signal is an audible feedback signal.

8. The method according to claim 3, wherein said signaling device is a mechanical signaling device, and said humanly perceptible feedback signal is a tactile feedback signal.

9. The method according to claim 3, wherein said signaling device includes a combination of at least two of an optical signaling element, an acoustic signaling element, and a mechanical signaling element, and wherein said humanly perceptible feedback signal correspondingly includes a combination of at least two of a visible feedback signal, an audible feedback signal, and a tactile feedback signal.

10. The method according to claim 1, wherein said step c) comprises providing said quality feedback information signal only when said speech quality is determined as being unacceptable.

11. The method according to claim 1, wherein said step c) comprises providing said quality feedback information signal only when said speech quality is determined as being acceptable.

12. The method according to claim 1, wherein said step c) comprises providing said quality feedback information signal respectively both when said speech quality is determined as being unacceptable and when said speech quality is determined as being acceptable, whereby said quality feedback information signal is respectively indicative of said speech quality determined as being unacceptable and indicative of said speech quality determined as being acceptable whenever applicable.

13. The method according to claim 12, wherein said step c) comprises providing said quality feedback information signal continuously during all of said step a).

14. The method according to claim 1, wherein said signaling device emits a humanly perceptible instruction as to improving said speech quality that has been determined as being unacceptable.

15. The method according to claim 1, further comprising providing said converted signal, with or without further processing, to an audio output device including a loudspeaker, regardless whether said evaluating in said step b) determines that said speech quality is acceptable or unacceptable.

16. The method according to claim 1, wherein said evaluating in said step b) comprises analyzing at least one of a signal-to-noise ratio, a signal level magnitude, and a signal level constancy of said converted signal.

17. The method according to claim 1, wherein said evaluating in said step b) is carried out within said speech receiving device.

18. The method according to claim 1, wherein said steps b) and c) are carried out in real-time during said step a).

19. The method according to claim 1, further comprising:
generating said speech signal by a human speaker speaking said speech signal;
emitting from said signaling device a feedback signal that is perceptible by said human speaker in response to said quality feedback information signal and dependent on and indicative of said speech quality; and
when said speech quality is determined as being unacceptable, then further comprising said human speaker taking corrective measures in response to said feedback signal, said corrective measures selected from the group consisting of speaking more clearly, speaking more loudly, changing a spacing distance between said microphone and said human speaker's mouth, and changing a relative angular orientation or position of said microphone relative to said human speaker's mouth.

20. The method according to claim 1, further comprising allocating a measure for said speech quality to said speech signal, wherein said step b) is carried out in a speech analysis and evaluation arrangement incorporated in said speech receiving device, and wherein said speech receiving device is a component of, and said method is carried out in, an aircraft speech transmission arrangement on board an aircraft.

21. An apparatus for processing a speech signal, comprising:
a speech receiving device including a microphone and a speech evaluation arrangement that is incorporated in said speech receiving device, connected to an output of said microphone, and adapted to evaluate a speech quality of a speech signal received by said microphone and to provide a quality feedback information signal indicative of said speech quality at a feedback output of said speech evaluation arrangement;
an audio output device that is separate from said speech receiving device and that is connected directly or indirectly to said output of said microphone or to a speech signal output of said speech evaluation arrangement; and
a signaling device that is connected to said feedback output of said speech evaluation arrangement so as to receive said quality feedback information signal, adapted to emit a humanly perceptible feedback signal responsive to said quality feedback information signal and indicative of said speech quality, and arranged at a location within a range of perception of said feedback signal by a human user of said speech receiving device.

22. The apparatus according to claim 21, wherein said signaling device is incorporated in said speech receiving device.

23. The apparatus according to claim 21, wherein said speech evaluation arrangement comprises a programmable processing and computing unit and a speech processing software program loaded therein.

24. The apparatus according to claim 21, wherein said signaling device comprises one of a visual display unit, a vibrator element, and a loudspeaker unit.

25. The apparatus according to claim 21, wherein said signaling device comprises a plurality of different ones of a visual display unit, a vibrator element, and a loudspeaker unit.

26. The apparatus according to claim 21, wherein said speech receiving device is a portable telephone-style receiver handset.

27. The apparatus according to claim 21, incorporated in an aircraft speech transmission arrangement on board an aircraft.
